(19) United States
(12) Patent Application Publication
(10) Pub. No.: US 2020/0107907 A1
(43) Pub. Date: Apr. 9, 2020

(54) ORTHODONTIC BRACE

(71) Applicant: YUN-WEN DENG, New Taipei City (TW)

(72) Inventor: YUN-WEN DENG, New Taipei City (TW)

(21) Appl. No.: 16/151,325

(22) Filed: Oct. 3, 2018

(51) Int. Cl. A61C 7/08; A61C 7/36

(52) U.S. Cl. CPC A61C 7/08; A61C 7/303; A61C 7/36

(57) ABSTRACT

An orthodontic brace provided by the present invention can be removably set on a user's dental arch, correcting the dental arch from an original contour to an objective contour. The orthodontic brace includes a plurality of elastic arms that contact with a lingual side or a buccal side of the dental arch, and a corrective contour is constructed by the mutual connection of the elastic arms. The corrective contour fits in at least partial objective contour. At least one elastic arm will be compressed or expanded against by the dental arch, further generating elastic force acting on the dental arch. Wherein, the heights of the elastic arms are not over that of an occlusal surface of the dental arch to prevent saliva from being gathered in the orthodontic brace, which solves other past problems derived from the thickness of the braces at the occlusal surface.

### FIELD OF THE DISCLOSURE

The present invention relates to an orthodontic brace, and more particularly to a type of orthodontic brace set on a dental arch for correcting teeth arrangement.

### BACKGROUND

In addition to being more aesthetical in look, the neatly arranged teeth can also reduce unnecessary wear of the teeth, reduce the blind corner when brushed, or reduce the burden on the temporomandibular joints. In order to make the inborn bad-arranged (misarranged?) teeth neat, a brace is an indispensable component of orthodontics.

In convention orthodontics, it mainly gradually changes the arrangement of teeth by means of sticking brace on the surface of teeth for connecting to form a brace archwire that is bent into a shape like a dental arch, and the continuously applied force through the brace archwire; however, there are many problems in using a brace bonded onto the teeth; in addition to the aesthetics problem, the conventional brace has a certain volume and thickness which makes the wearer uncomfortable, and its edge is also easy to scratch the tongue or the cheek, causing skin loss or mucosal ulcers.

Therefore, some manufacturers have developed a type of braces that need not be attached to the surface of the teeth, then the user is allowed to wear or remove the braces (such as Invisalign brace) by user, and correct the teeth in the way of gradually changing the position of teeth by wearing different-shaped braces one by one.

Wherein, the most common appearance of this type of braces is a shell of uniform thickness slid over whole crown produced by 3D printing or vacuum forming of the plastic sheet. Such a semi-closed shell design easily brings about odor because of saliva easily being gathered inside. Since the occlusal surface of the shell has a certain thickness, it is easily unable to close the oral cavity normally, affect the pronunciation and has drool problem during wearing brace and occluding. Further, in addition to the occlusal surface of the braces can be broken by user's actions such as grinding teeth during wearing brace, and then the whole brace need be replaced. With the time extension of correction, the open bite of posterior teeth could arise after long-term wearing.

### SUMMARY OF THE INVENTION

The main purpose of the present invention is to provide an orthodontic brace for not covering the occlusal surface during wearing, which prevents saliva from being gathered inside and avoids other problems derived from the thickness of the braces at the occlusal surface.

To achieve above purpose, the orthodontic brace of the present invention can be removably set on a user's dental arch, correcting the dental arch from an original contour to an objective contour with the shape different from that of original contour. The orthodontic brace comprises a plurality of elastic arms that contact with a lingual side or a buccal side of the dental arch, and a corrective contour is constructed by the mutual connection of the elastic arms. The corrective contour fits in at least partial objective contour and has at least one inflection at connection of the two elastic arms. While orthodontic brace is set on the dental arch with the original contour, at least one elastic arm will be compressed or expanded against by the dental arch, further generating an elastic force acting on the dental arch by taking the inflection as a pivot point. Wherein; the heights of the elastic arms are not over that of an occlusal surface of the dental arch.

As for the way of action, in one embodiment, the elastic arms comprises a first elastic arm and a second elastic arm contacting with the lingual side or the buccal side of the dental arch. When the orthodontic brace is set on the dental arch of the original contour, the first elastic arm and the second elastic arm jointly form an action section of pushing the dental arch.

To change local positions, the first elastic arm has a first thickness and the second elastic arm has a second thickness in one embodiment and the second thickness is larger than the first thickness, so that when the orthodontic brace is set on the dental arch of the original contour, the first elastic arm forms a first action section exerting larger pushing effect on the dental arch but the second elastic arm forms a second action section exerting smaller pushing effect on the dental arch.

Further, to more stably fix the orthodontic brace on the dental arch in another embodiment, the elastic arms are arranged with a wrap portion at one end. The wrap portion having a bend, together with the elastic arms, jointly encircle around at least one tooth of the dental arch from the lingual side and the buccal side.

In one various embodiment similarly to previous ones, in order to adjust the teeth in the separate section (as well as the teeth around by the wrap portion), a wall surface constructing the warp portion has a first thickness while the elastic arms connecting to the warp portion have a second thickness, wherein the second thickness is larger than the first thickness.

In another various embodiment similar to previous ones, in order to adjust separate tooth, a tensile portion may be arranged between the elastic arms and the wrap portion. A wall thickness of the tensile portion is smaller than the thickness of the elastic arm and the wrap portion.

As for change of the elastic arms, in one embodiment, the elastic arms have a projection formed toward the lingual side or the buccal side. The projection is disposed in the gap between adjacent teeth in the dental arch. The gap between adjacent teeth can be changed by the projection.

In another embodiment, in order to adjust the occlusal surface between the mandible and the palate, one side of the projection adjacent to the occlusal surface is aligned with the occlusal surface, such that the dental arch at the other side could be push against by the projection when occluding.

As for various types, in addition to the design of only mounting at the lingual side or the buccal side alone, in one embodiment, the orthodontic brace comprises an inner elastic arm contacting with the lingual side of the dental arch and an outer elastic arm contacting with the buccal side of the dental arch. Two ends of the outer elastic arm separately connects to two ends of the inner elastic arm through two bends, which makes the lingual side and the buccal side of the dental arch are completely surrounded and covered by the orthodontic brace.

At last, for the problem of adjusting the position of the whole dental arch, a fixed member (in various embodiments, it can be cut directly in the elastic arms, or a hook extending outward from the elastic arms or a rod having a recess) adapt to be attached by a resilient element may form on the elastic arms, and through the fixed member the resilient element exerts external force on the elastic arms in a direction different from that of force by the elastic arms.

According to the above description, the present invention is characterized in that the orthodontic brace corresponding to different correction requirement are generated in a manner of shape variation or thickness variation on partial elastic arms and the orthodontic brace just covers the lingual side or the buccal side of the teeth without covering the occlusal surface of the teeth in normal condition, so that the occlusal height of the upper and lower rows of teeth is not affected by the thickness problem and the closure is normal. Further, the pronunciation is not affected and there is no drool problem or open bite because of normal closure. Yet because the occlusal surface is not covered, the structure of the orthodontic brace wouldn't be broken for impact from the external force and saliva can be in and out normally without gathering, not easily generating the odor.

### BRIEF DESCRIPTION OF THE DRAWINGS

To more clearly illustrate embodiments of the application or technical solutions in the prior art, drawings to be used in the description of the embodiments of the application or the prior art will be briefly introduced hereinafter. Apparently, the drawings in the description below are merely some embodiments of the disclosure, a person skilled in the art can obtain other drawings according to these drawings without creative efforts. In the figures:

FIG. 1 is a schematic illustrating the orthodontic brace of the present invention in one embodiment;

FIG. 2 is a schematic illustrating the orthodontic brace of the present invention in another embodiment;

FIG. 3 is a schematic side view of the embodiment in FIG. 2;

FIG. 4 is a schematic illustrating cross section of the dental arch in the embodiment of FIG. 2;

FIG. 5 is a schematic illustrating the orthodontic brace of the present invention in another category of embodiment;

FIG. 6 is a schematic illustrating the orthodontic brace of the present invention in one embodiment;

FIG. 7 is a schematic illustrating the orthodontic brace of the present invention in one embodiment;

FIG. 8 is a schematic illustrating the orthodontic brace used for local portion correction of the present invention in one embodiment;

FIG. 9 is a schematic illustrating the orthodontic brace used for local portion correction of the present invention in another embodiment;

FIG. 10 is a schematic illustrating the orthodontic brace used for local portion correction of the present invention in yet another embodiment;

FIG. 11A is a schematic illustrating the orthodontic brace of the present invention in another category of embodiment;

FIG. 118 is a schematic illustrating the orthodontic brace of the present invention in another embodiment;

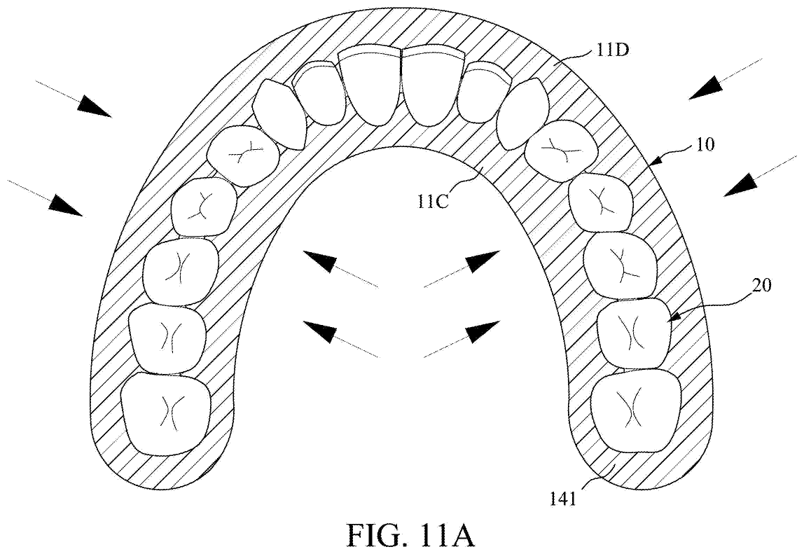

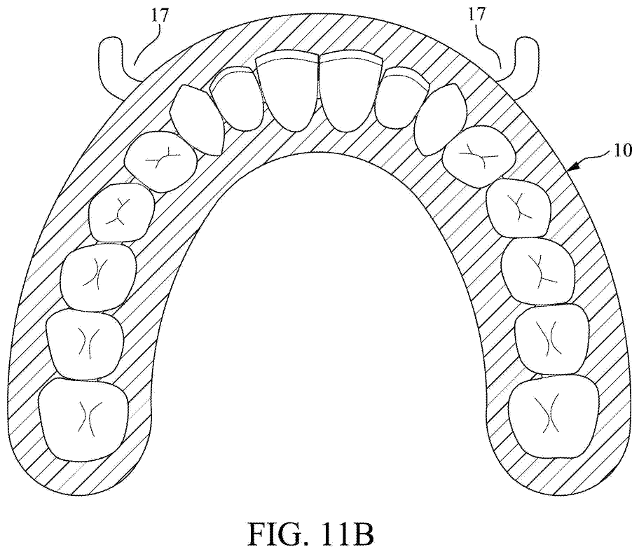

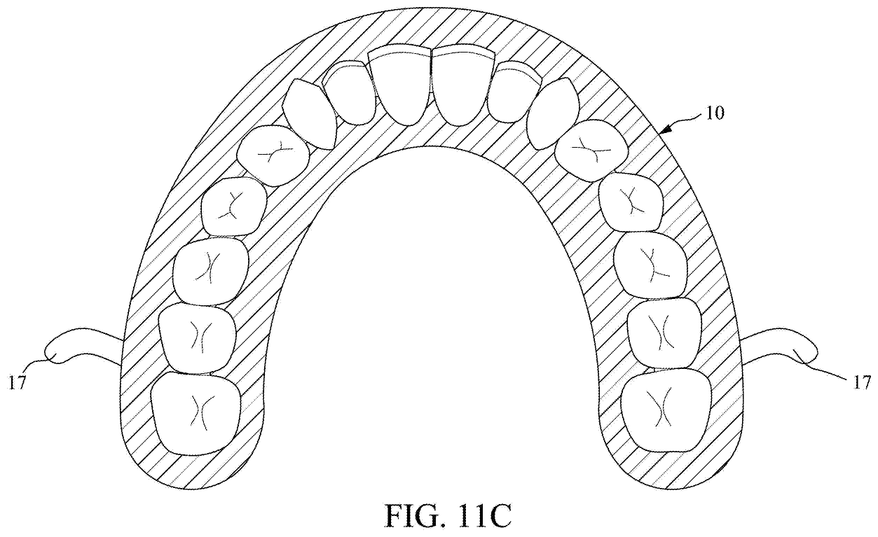

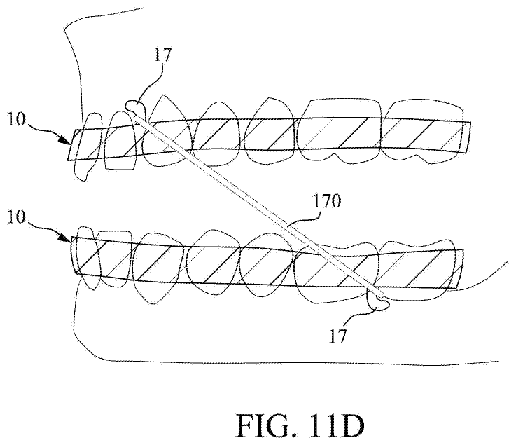

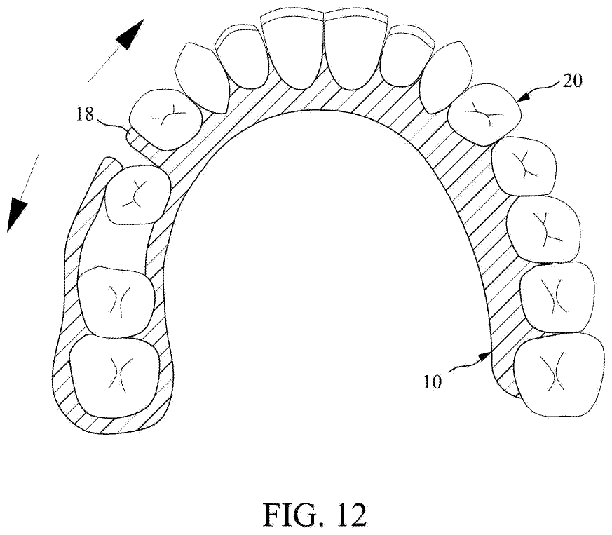

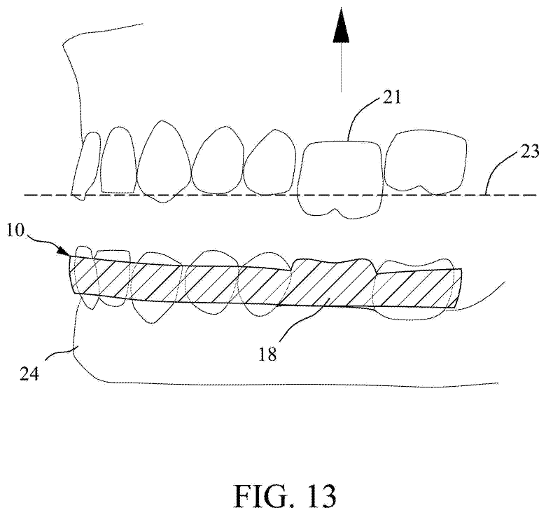

FIG. 11C is a schematic illustrating the orthodontic brace of the present invention in another embodiment;

FIG. 11D is a schematic illustrating the combination use of the orthodontic brace in FIG. 11B and FIG. 11C;

FIG. 12 is a schematic illustrating the orthodontic brace used for local portion change of the present invention in another embodiment; and

FIG. 13 is a schematic illustrating the orthodontic brace used for local portion change of the present invention in yet another embodiment.

### DETAILED DESCRIPTION OF THE PREFERRED EMBODIMENTS

In order to further understand the structure, usage and features of the present disclosure more clearly, the present disclosure is described in detail below with references to the accompanying drawings and specific preferred embodiments.

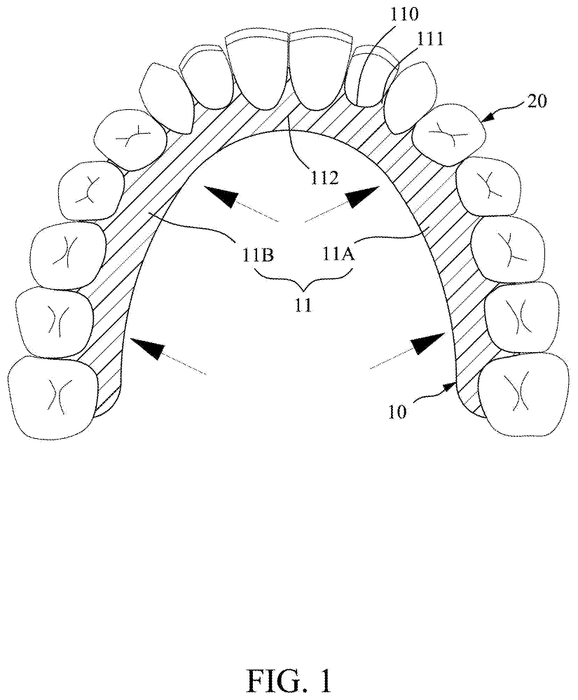

Please refer to FIG. 1 through FIG. 12. An orthodontic brace 10 of the present invention comprises a body which can be removably set on a user's dental arch 20, making the dental arch 20 corrected from an original contour before using the orthodontic brace 10 to an objective contour (the contour is determined by an orthodontist, which is unnecessarily a complete contour during correction and also may be just a contour of transition) different from the original contour in shape. The body comprises two elastic arms 11 contacting with a lingual side or a buccal side of the dental arch 20. These two elastic arms are arranged with a plurality of fitting grooves 110 having shapes substantially matching those of crown 22 sides of each tooth 21 in the dental arch 20 and a plurality of fitting ridges 111 among the fitting grooves 110. The elastic arms 11 connect with each other to form a corrective contour similar to the objective contour, and the corrective contour fits in at least part of the objective contour and has at least one inflection 112 at connection of these two elastic arms 11. Because there is contour difference between the original contour of the dental arch 20 and the corrective contour of the orthodontic brace 10, when the orthodontic brace 10 is set on the dental arch 20 of the original contour, at least one elastic arm 11 will be compressed or expanded against by the dental arch 20, further generating an elastic force acting on the dental arch 20 to affect teeth 21 by inflection 112 as a pivot point.

Please refer to FIGS. 1 to 4. In the embodiment of FIG. 1, the orthodontic brace 10 is set by the lingual side of the dental arch 20, and the elastic arms 11 comprises a first elastic arm 11A and a second elastic arm 11B contacting with the lingual side of the dental arch 20. When the orthodontic brace 10 is set on the dental arch 20 of the original contour, the first elastic arm 11A and the second elastic arm 11B jointly form a pushing section to push against the dental arch 20 (as arrow direction shown in figure), making the dental arch 20 corrected from the crowded original contour to the objective contour that is expanded and formed in the different shape of the original contour.

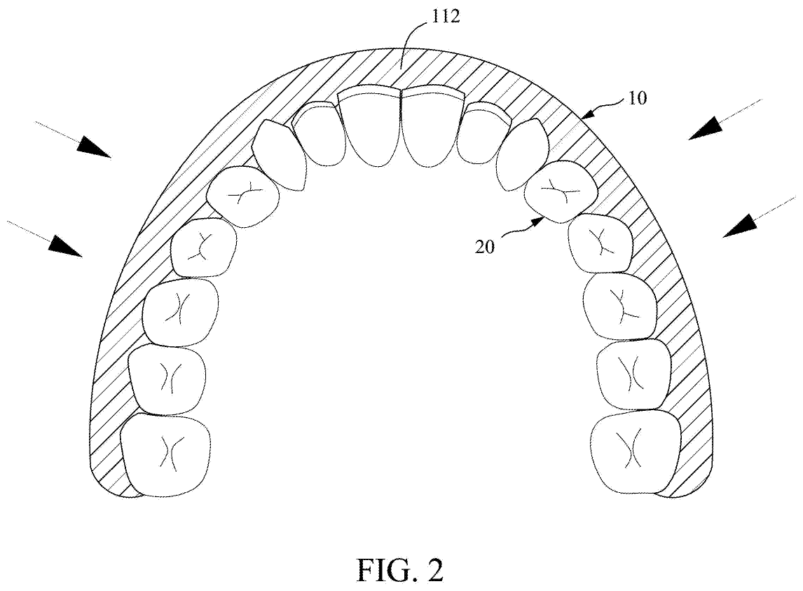

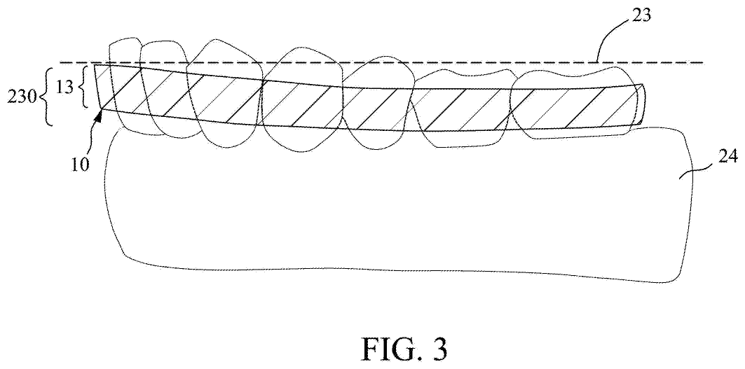

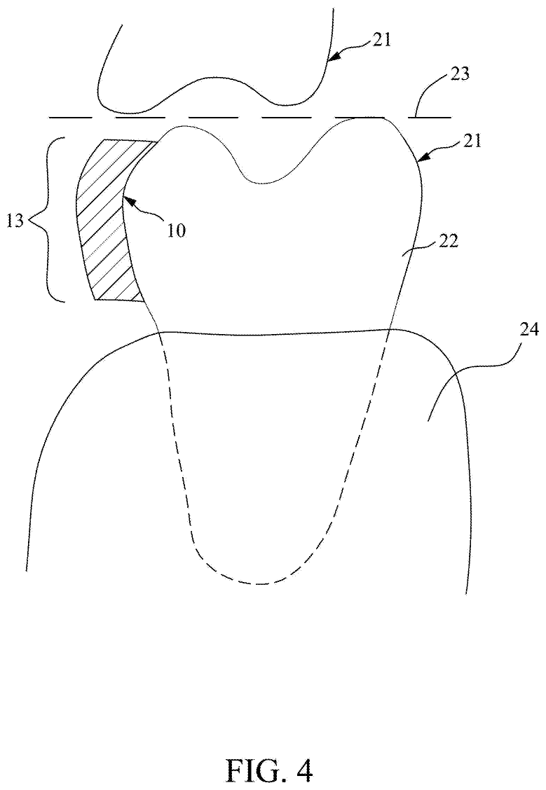

However, the mounting position of the orthodontic brace 10 is not limited in the present invention, and its arrangement changes by requirement can affect the way the orthodontic brace 10 acting on the dental arch 20. For example, in the embodiment of FIG. 2, the orthodontic brace 10 is set by the buccal side of the dental arch 20, which making the dental arch 20 of larger interdental space shrink from the oversized-gaped original contour 21 to the objective contour different from the shape of the original contour. Wherein as shown in FIG. 3 and FIG. 4, in the orthodontic brace 10 of the present invention, the side wall heights 13 of a plurality of the elastic arms 11 are all not over an occlusal surface height 230 between the occlusal surface 23 of the dental arch 20 and gums (not shown in the figure). Thus when mounted, the orthodontic brace 10 only contacts with the crown 22 sides of the teeth 21 but does not cover the occlusal surface 23 of the crown 22, which would not cause height varying to the occlusal surface 23 between the mandible and the palate. And it will not bring about the problems of gathering saliva or affecting pronunciation as traditional braces.

Further, the shape of cross section is not limited in the orthodontic brace 10 of present invention. In the embodiment of FIG. 4, the orthodontic brace 10 may be an uniform-thick element, so that its cross section substantially shows a shape of a rectangle matching the curvature of the teeth 21 surface. However, in other embodiments, the shape of the cross section may be others, such as a triangle, a semi arch, etc.

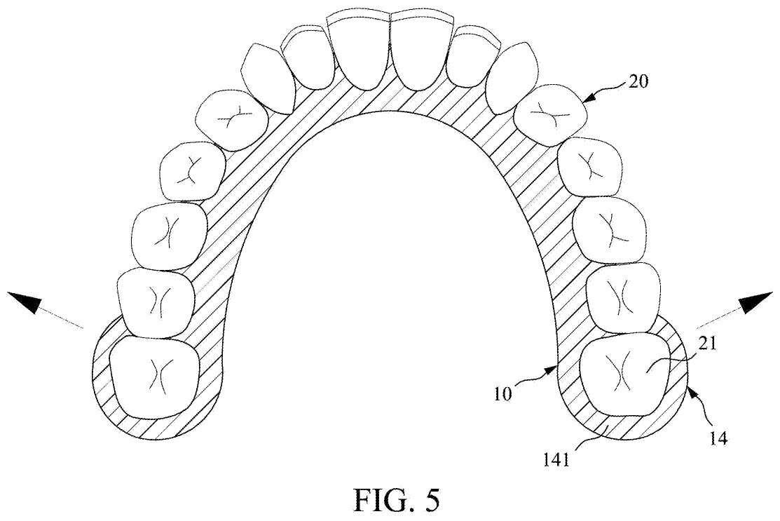

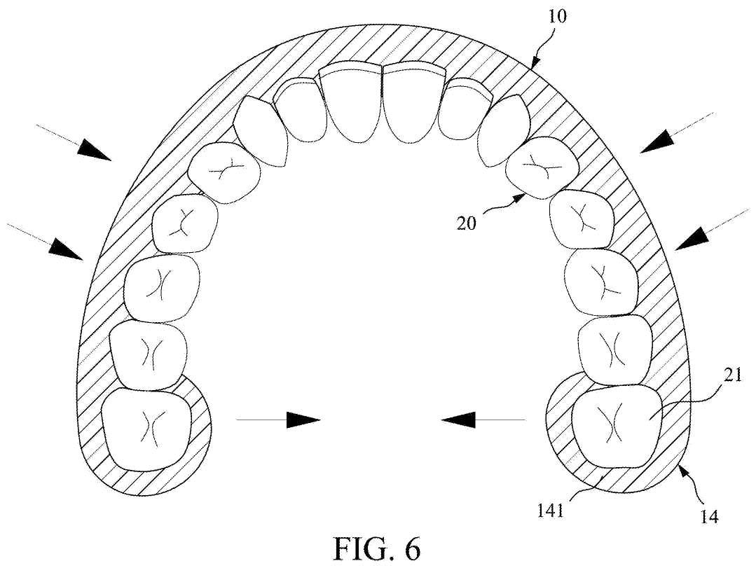

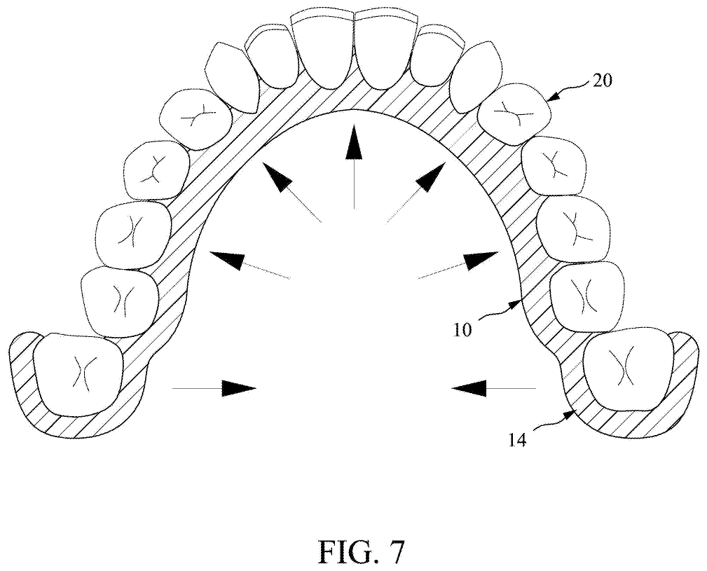

Please refer to FIGS. 5 to 7. To enhance the connection between the orthodontic brace 10 and the dental arch 20 further to prevent the orthodontic brace 10 from being easily detached from the dental arch 20 in the process of pushing, the elastic arms 11 are arranged with a wrap portion 14 at one end in the embodiments of FIG. 5 to FIG. 7. The wrap portion 14 having a bend 141, together with the elastic arms 11, jointly encircle around at least one tooth 21 from both directions of the lingual side and the buccal side at the end of the dental arch 20; wherein in the embodiments shown in FIG. 5 and FIG. 6, the wrap portions 14 separately encircle around the tooth 21 at two ends of the dental arch 20. In the embodiment shown in FIG. 7, because the elastic arms 11 exerts force on the teeth 21 in accordance with direction difference between the corrective contour of the orthodontic brace 10 and the objective contour, the force on the teeth 21 around by the wrap portion 14 may be opposite to that on the remaining teeth 21 in the dental arch 20 (as the arrow direction shown in FIG. 7) in the embodiment shown in FIG. 7, so as to adjust the positions of the teeth 21 at the ends of the dental arch 20 and make the objective contour of the dental arch 20 into a complete arc when the teeth 21 at the ends of the dental arch 20 offset other remaining teeth 21 of the dental arch 20.

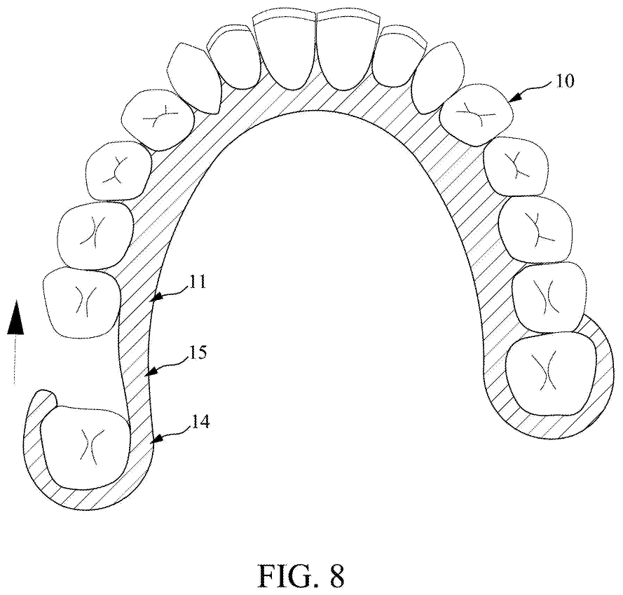

Please refer to FIG. 8, with reference to other various design of applying in the wrap portion 14. In one embodiment, to pull the separate tooth 21 and reduce the gap between the adjacent teeth 21, a tensile portion 15 may be arranged between the elastic arms 11 and the wrap portion 14. The thickness of the tensile portion 15 is smaller than the thickness of the wrap portion 14 and the elastic arms 11 for pulling the teeth 21 around by the wrap portion 14.

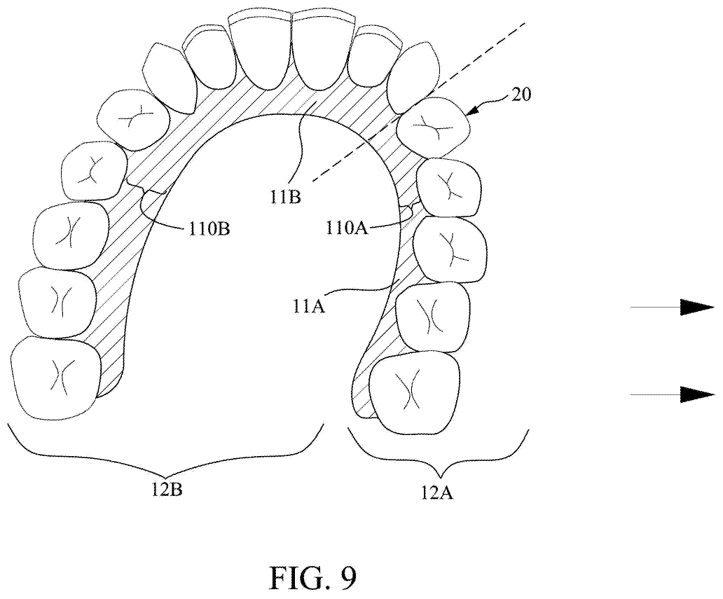

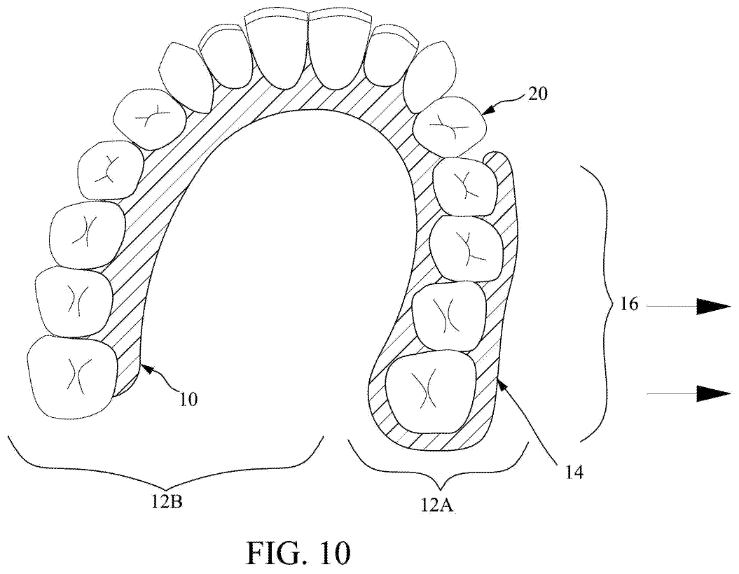

As shown in FIG. 9 to FIG. 10, with respect to a category of embodiments, in order to simultaneously change arrangement of many teeth 21 at one side of the dental arch 20, for example in the embodiment of FIG. 9 and FIG. 10, one side of the dental arch 20 is fixed for expanding the other side of the dental arch 20. And the elastic arms 11 include a first elastic arm 11A and a second elastic arm 11B with a thickness different from the first elastic arm 11A, which contact with the lingual side of the dental arch 20 (the buccal side may be in other embodiments). When the orthodontic brace 10 is set on the dental arch 20 of the original contour, the first elastic arm 11A and the second elastic arm 11B simultaneously form an action section to push against the dental arch 20 (as arrow direction shown in figure). As shown in FIG. 9, the first elastic arm 11A has a first thickness 110A and the second elastic arm 11B has a second thickness 110B. Because the first thickness 110A is less than the second thickness 110B, the first elastic arm 11A can form a first action section 12A exerting larger pushing effect on the dental arch 20 while the second elastic arm 11B form a second action section 12B exerting smaller pushing effect on the dental arch 20 when the orthodontic brace 10 is set on the dental arch 20 of the original contour.

Otherwise, as shown in FIG. 10, with respect to other embodiments, the first action section 12A may be arranged with the wrap portion 14 and together with the wrap portion 14 form a U-shaped structure 16 encircle around a plurality of teeth 21. Similarly, in order to make pushing force difference between the teeth 21 around by the wrap portion 14 and the teeth 21 without around by the wrap portion 14, a wall surface constructing the warp portion 14 has a first thickness 110A while the elastic arms 11 not constructing the warp portion 14 in the body has a second thickness 110B; further, in the same way, the first thickness 110A is less than the second thickness 110B.

Please refer to FIG. 11A to FIG. 12D. To simultaneously change the shape of the whole dental arch 20, in the embodiment of FIG. 9A, the orthodontic brace 10 comprises an inner elastic arm 11C contacting with the lingual side of the dental arch 20 and an outer elastic arm 11D contacting with the buccal side of the dental arch 20. Two ends of the outer elastic arm 11D separately connects to two ends of the inner elastic arm 11C through two bends 141, which makes the lingual side and the buccal side of the dental arch 20 completely surrounded and covered by the orthodontic brace 10; however, similarly, the orthodontic brace 10 does not cover the occlusal surface 23.

Additionally, please refer to FIGS. 11B and 11C. In the previous embodiments, when the orthodontic brace 10 changes the shape of the dental arch 20, the alignment just relies on the relative positional relationship among the teeth 21 of the dental arch 20 instead of changing on a reference point as a standard in the oral cavity. Therefore, in the embodiments of FIG. 11C, a fixed member 17 adapts to be attached by a resilient element 170 (e.g., a rubber band or spring attached to a peg placed in the oral cavity) may form on the elastic arms 11 in the orthodontic brace 10. And thus, through the fixed member 17 the resilient element 170 exerts external force on the elastic arms 11 in a direction different from that of force by the elastic arms 11, which is used for positioning the orthodontic brace 10;

Please refer to what shown in FIG. 11D. In the embodiment, resilient element 170 simultaneously connects to the orthodontic brace 10 at the dental arch 20 of the mandible and the palate, then the positions of the teeth 21 in the dental arch 20 of the mandible and the palate could match with each other; wherein, there is no limitation about the way how the fixed member 17 forms, the number of the fixed member 17 or the position of the fixed member 17 in the present invention. In the embodiments of FIG. 9B through FIG. 9D, the fixed member 17 may be a groove on the small hook extending from the elastic arms 11. In other embodiments, the fixed member 17 may be a rod extending from the elastic arms 11 or be a groove directly formed on the elastic arms 11 by means of wall thickness of the elastic arms 11.

The orthodontic brace 10 provided by the present invention could also create a space for dental implant through the way of pushing. Please refer to FIG. 12, in the embodiment, the elastic arms 11 of the orthodontic brace 10 have a projection 18 formed toward the lingual side or the buccal side (according to the position of the tooth gap relative to the elastic arms 11). The projection 18 is disposed in the gap between adjacent teeth 21 in the dental arch 20 and similarly orthodontic brace 10 are arranged with the wrap portion 14; similarly, to enlarge the tooth gap, the wrap portion 14 has a second wall thickness 110B less than a first wall thickness 110A of the elastic arms 11.

At last, in some case of malocclusion, that is, in the case where the teeth 21 of the mandible and the palate are occluding, the teeth 21 on one side of the mandible and the palate have gaps therein, so that the teeth 21 on the other side do not have the teeth to match at the time of occlusion. It will change the occlusal surface 23 of the original dental arch, because of the teeth 21 gradually extending toward the other side. Therefore in the embodiment of FIG. 13, the elastic arms 11 of the orthodontic brace 10 similarly have the projection 18 formed toward the lingual side or buccal side (according to the position of the tooth gap relative to the elastic arms 11). Further, one side of the projection 18 proximate to the occlusal surface 23 is aligned with the occlusal surface 23, so that the teeth 21 otherwise not pushed by the teeth 21 at the other side could be pushed against by the projection 18 and not gradually extend, thereby maintaining the position of the occlusal surface 23 at the side.

The above-mentioned embodiments are used for conveniently describing the present invention, not further to limit it. it would be appreciated by those skilled in the art that various changes or modifications may be made in these embodiments without departing from the principles and spirit of the present invention, the scope of which is defined in the claims and their equivalents.

What is claimed is:

1. An orthodontic brace able to be removably mounted on a dental arch of a user to correct the dental arch from an original contour to an objective contour with the shape different from the original contour, wherein the orthodontic brace comprising:
a plurality of elastic arms contacting with a lingual side or a buccal side of the dental arch;
wherein a corrective contour is constructed by the mutual connection of the elastic arms and the corrective contour fits in at least partial objective contour and has at least one inflection at connection of the two elastic arms;
wherein while orthodontic brace is set on the dental arch with the original contour, at least one elastic arm will be compressed or expanded against by the dental arch, further generating elastic force acting on the dental arch by inflection as a pivot point; and
wherein the heights of the elastic arms are not over that of an occlusal surface of the dental arch.

2. The orthodontic brace according to claim 1, wherein the elastic arms includes a first elastic arm and a second elastic arm contacting with the lingual side or the buccal side of the dental arch, and wherein when the orthodontic brace is set on the dental arch of the original contour, the first elastic arm and the second elastic arm jointly form an action section of pushing the dental arch.

3. The orthodontic brace according to claim 2, wherein the first elastic arm has a first thickness and the second elastic arm has a second thickness and the second thickness is larger than the first thickness, so that when the orthodontic brace is set on the dental arch of the original contour, the first elastic arm forms a first action section exerting larger pushing effect on the dental arch but the second elastic arm forms a second action section exerting smaller pushing effect on the dental arch.

4. The orthodontic brace according to claim 1, wherein the elastic arms are arranged with a wrap portion at one end, and the wrap portion having a bend, together with the elastic arms, jointly winds around at least one tooth of the dental arch from the lingual side and the buccal side.

5. The orthodontic brace according to claim 4, wherein a wall surface constructing the warp portion has a first thickness while the elastic arms connecting to the warp portion have a second thickness, wherein the second thickness is larger than the first thickness.

6. The orthodontic brace according to claim 4, wherein a tensile portion is arranged between the elastic arms and the wrap portion, and a wall thickness of the tensile portion is smaller than that of the elastic arm and the wrap portion.

7. The orthodontic brace according to claim 1, wherein a the elastic arms have a projection formed toward the lingual side or the buccal side, the projection is disposed in the gap between adjacent teeth in the dental arch.

8. The orthodontic brace according to claim 7, wherein one side of the projection adjacent to the occlusal surface is aligned with the occlusal surface.

9. The orthodontic brace according to claim 1, wherein the orthodontic brace includes an inner elastic arm contacting with the lingual side of the dental arch and an outer elastic arm contacting with the buccal side of the dental arch, and two ends of the outer elastic arm separately connects to two ends of the inner elastic arm through two bends, which makes the lingual side and the buccal side of the dental arch completely surrounded and covered by the orthodontic brace.

10. The orthodontic brace according to claim 1, wherein a groove adapt to be attached by a resilient element forms on the elastic arms, and through the groove the resilient element exerts external force on the elastic arms in a direction different from that of force by the elastic arms.
